(19) United States
(12) Patent Application Publication
(10) Pub. No.: US 2015/0100901 A1
(43) Pub. Date: Apr. 9, 2015

(54) INFORMATION PROCESSING DEVICE, METHOD, AND PROGRAM

(71) Applicant: NEC Personal Computers, Ltd, Tokyo (JP)

(72) Inventors: Yoichiro Yamanaka, Tokyo (JP); Yasunari Yagi, Tokyo (JP)

(73) Assignee: NEC Personal Computers, Ltd, Tokyo (JP)

(21) Appl. No.: 14/509,618

(22) Filed: Oct. 8, 2014

(30) Foreign Application Priority Data
Oct. 8, 2013 (JP) 2013-210926

(51) Int. Cl. G06F 3/0489; G06F 3/0488; G06F 3/0481; G06F 3/0486; G06F 3/0484

(52) U.S. Cl. CPC G06F 3/04897; G06F 3/0486; G06F 3/04847; G06F 3/04812; G06F 3/04817; G06F 3/04886
USPC 715/761

(57) ABSTRACT

An extended display utilization environment is provided that permits comfortable operation. An information processing device includes: a touch panel for displaying a virtual touchpad in a first region serving as a part of an entire display region; startup judging means of, when an icon displayed in the display region of the touch panel and causing execution of predetermined processing of an application related, in advance by predetermined operation is dragged and dropped into the first region, performing control of starting an application concerning the icon and then displaying a display screen of the application on an external display; pointer display control means of performing control of displaying a pointer on the display screen of the external display; and pointer operation input receiving means of receiving input of user operation to the first region, as input of operation of the pointer. Then, the pointer display control means controls display of the pointer on the basis of the input of operation of the pointer.

### BACKGROUND OF THE INVENTION

1. Field of the Invention

The present invention relates to an information processing device, a method, and a program and, in particular, to those displaying a screen of an application onto an external display.

2. Related Art

Patent Document 1 discloses a technique that drag and drop operation is abstracted and then, when a thumbnail such as a video image is dragged and dropped onto a predetermined icon, an application is started so that full screen display is performed on a secondary display.

Patent Document 2 discloses a technique that the entire region of the plane on the near side relative to the keyboard of a notebook computer is constructed as a touch panel and then a part of the region is used as a touchpad.

Patent Document 1 Japanese Patent Laid-Open Publication No. 2010-528368

Patent Document 2 Japanese Patent Laid-Open Publication No. 2010-066915

### SUMMARY OF THE INVENTION

A technique that a screen of an application is expanded on a secondary display other than a main display is disclosed in Patent Document 1. A technique that a part of the region of a touch panel is used as a touchpad is disclosed in Patent Document 2. Nevertheless, these prior art disclosures do not describe information processing that in a so-called “tablet PC”, pointer input obtained when a part of the region of a touch panel is used as a touchpad is reflected in a secondary display.

The present invention has been devised in view of the above-mentioned situation. An object thereof is to provide an extended display utilization environment that permits comfortable operation.

The present invention devised for achieving the above-mentioned object is characterized by an information processing device comprising: a touch panel for displaying a virtual touchpad in a first region serving as a part of an entire display region; startup judging means of, when an icon displayed in the display region of the touch panel and causing execution of predetermined processing of an application related in advance by predetermined operation is dragged and dropped into the first region, performing control of starting an application concerning the icon and then displaying a display screen of the application on an external display; pointer display control means of performing control of displaying a pointer on the display screen of the external display; and pointer operation input receiving means of receiving input of user operation to the first region, as input of operation of the pointer, wherein the pointer display control means controls display of the pointer on the basis of the input of operation of the pointer.

According to the present invention, an extended display utilization environment can be provided that permits comfortable operation.

### BRIEF DESCRIPTION OF THE DRAWINGS

FIG. 1 is a diagram showing an exemplary configuration of external appearance according to an embodiment of the present invention.

FIG. 2 is a block, diagram showing an example of hardware and software configuration of an information processing device 100 shown in FIG. 1.

FIG. 3 is a functional block diagram according to the above-mentioned embodiment.

FIG. 4 is a diagram (part 1) showing an example of a display screen constructed according to the above-mentioned embodiment.

FIG. 5 is a flow chart showing a flow of start processing for an extended display utilization environment according to the above-mentioned embodiment.

FIG. 6 is a flow chart showing a flow of operation input processing in an extended display utilization environment according to the above-mentioned embodiment.

FIG. 7 is a diagram (part 2) showing an example of a display screen constructed. according to the above-mentioned embodiment.

FIG. 8 is a diagram (part 3) showing an example of a display screen constructed according to the above-mentioned embodiment.

### DESCRIPTION OF THE EMBODIMENTS

FIG. 1 shows an exemplary configuration of external appearance according to the present embodiment. As shown in the figure, an information processing system 1 according to the present embodiment may be constructed as a computer system including: an information, processing device 100 constructed from a personal computer of tablet type (a tablet PC, hereinafter); and an external display 102. The type of display device employed in the external display 102 may be of diverse type such as a liquid crystal type and an organic electroluminescence type. The information processing device 100 and the external display 102 are connected in a manner of permitting mutual communication. Employable methods of communication are not hunted to a particular one and the connection in the physical layer may be established, for example, through a display cable 103 as shown in the figure.

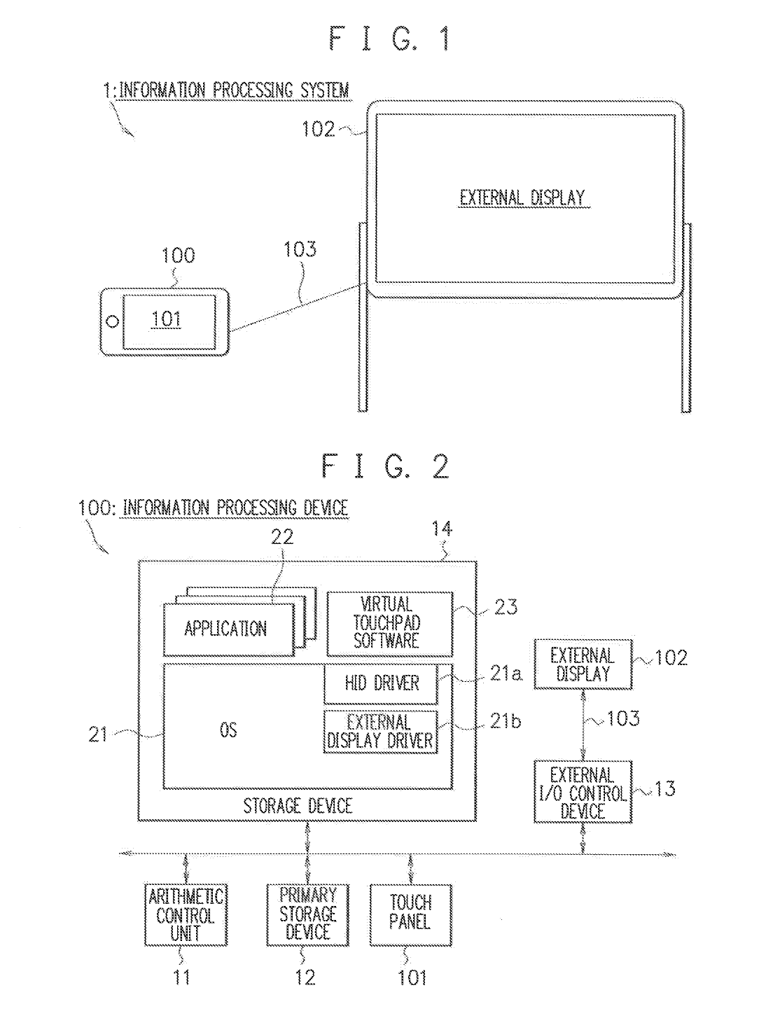

FIG. 2 shows an example of hardware and software configuration of the information processing device 100. In the information processing device 100, as the hardware, for example, a configuration may be employed that an arithmetic control unit 11, a primary storage device 12, an external I/O control device 13, a storage device 14, and a touch panel 101 are connected to each other through an internal bus. The external I/O control device. 13 can perform input and output concerning the external display 102 through the display cable 103.

The storage device 14 stores a software program group used for perform information. processing performed by the above-mentioned hardware. Such software includes an operating system (OS, hereinafter) 21, applications 22 which are various application software programs, and virtual touchpad software 23. As a part of the functions of the OS 21, a human interface device (HID, hereinafter) driver 21a and an external display driver 22b may also be included. The latter provides an interface used when the OS 21 operates the external display 102.

Here, the example of software configuration given above is an example adopted for description and may be modified variously. For example, the software may be provided by SaaS through a network. In the information processing achieved by the software program using the above-mentioned hardware, functional blocks described below are constructed. Further, the information processing is performed in accordance with a flow described later.

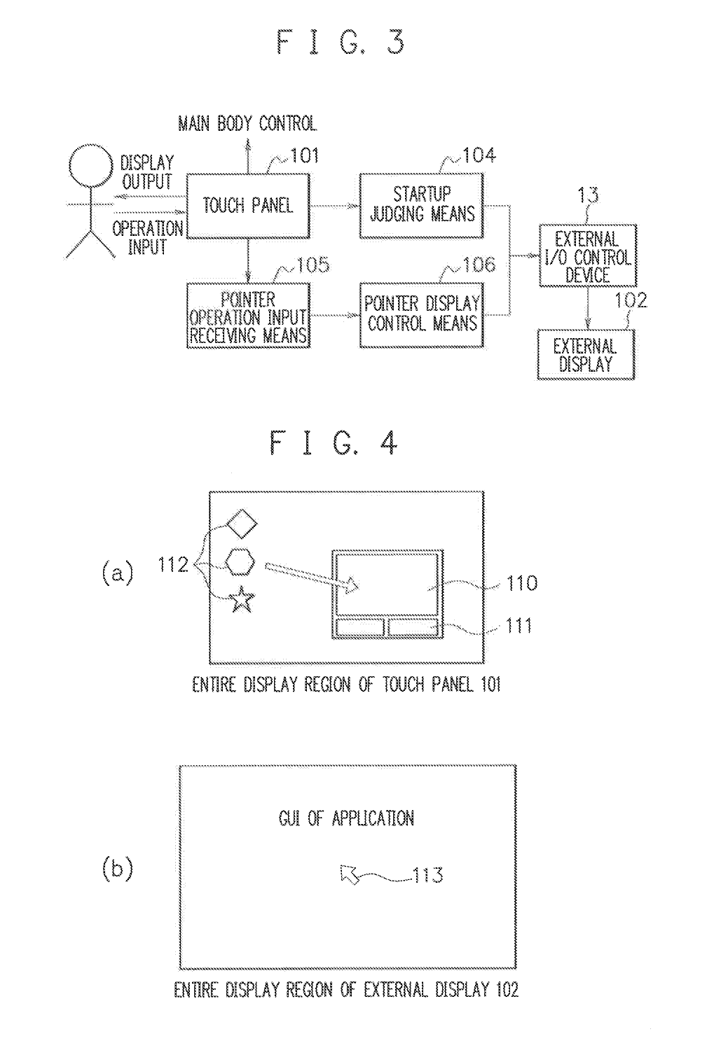

FIG. 3 shows a functional block diagram of the present embodiment. As shown in the figure, the information processing device 100 includes a touch panel 101, startup judging means 104, pointer operation input receiving means 105, and pointer display control means 106.

For example, the touch panel 101 is of electrostatic type and serves as display means as well as operation input means. FIG. 4 shows an example of a display screen according to the present embodiment. In the present embodiment, when the virtual touchpad software 23 is started, a virtual touchpad 110 shown in FIG. 4(a) is displayed on the touch panel 101. It is preferable that, as shown in FIG. 4(a), the virtual touchpad 110 is displayed such as to occupy a fixed area within the entire display region of the touch panel 101, Preferably, the virtual touchpad 110 includes a function key 111. The operation of the function key 111 is described later.

Further, as shown in FIG. 4(a), icons 112 are displayed in the display region of the touch panel 101. The icons 112 have a geometrical figure or an image in which when predetermined operation is performed thereon, predetermined processing is performed on an application related in advance to the icons 112, respectively. The icons 112 are respectively related in advance to one of the applications 22. The predetermined operation means click, double click, or the like. The predetermined processing means startup of the application 22, generation of a window or an instance, or the like.

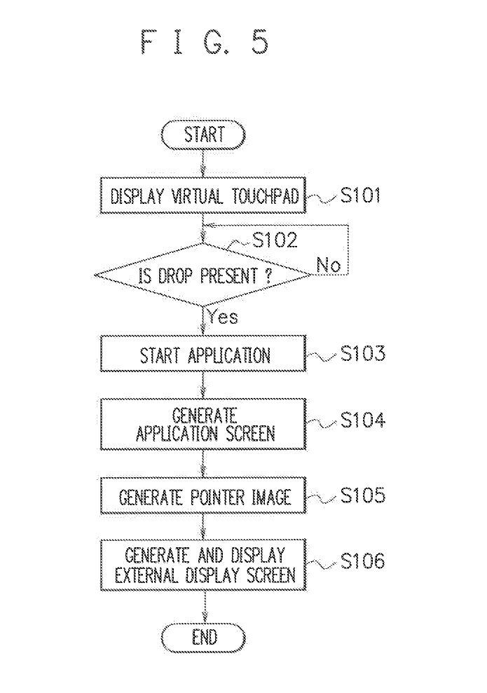

When the icon 112 is dragged and dropped into a predetermined region where the virtual touchpad 110 is displayed, the startup judging means 104 performs, the processing of starting the application 22 concerning the icon 112 having been dropped. The start processing for an extended display utilization environment using the virtual touchpad 110 is described below with reference to the flow chart shown in FIG. 5.

In FIG. 5, when the virtual touchpad software 23 is started, the virtual touchpad software 23 displays the virtual touchpad 110 on the touch panel 101 (S101). When dropping of the icon 112 into the virtual touchpad 110 is detected (S102/Yes), the startup judging means 104 starts the application 22 concerning the icon 112 (S103).

The startup judging means 104 has also the function of performing the control of displaying the display screen of the application 22 onto the external display 102. Further, the pointer display control means 106 has the function of perform the control of displaying a pointer 113 on the display screen of the external display 102. The pointer 113 is a pointer cursor in a graphical user interface (GUI, hereinafter) provided by the OS 21.

Specifically, as shown in FIG. 5, in accordance with the judgment by the startup judging means 104, the OS 21 generates a secondary display on a virtual desktop and then generates therein a screen of the application 22 to be started (S104). Further, the pointer display control means 106 generates also a pointer image (S105). A display driver (not shown) unities both so as to generate a screen of the external display 102. Then, the external display 102 performs actual display (S106).

FIG. 4(b) shows an example of a display screen of the external display 102. In the extended display of the external display 102, a pointer 113 absent in the touch panel 101 is displayed. Further, a screen of the application 22 having been started is displayed. This display may be of full screen display.

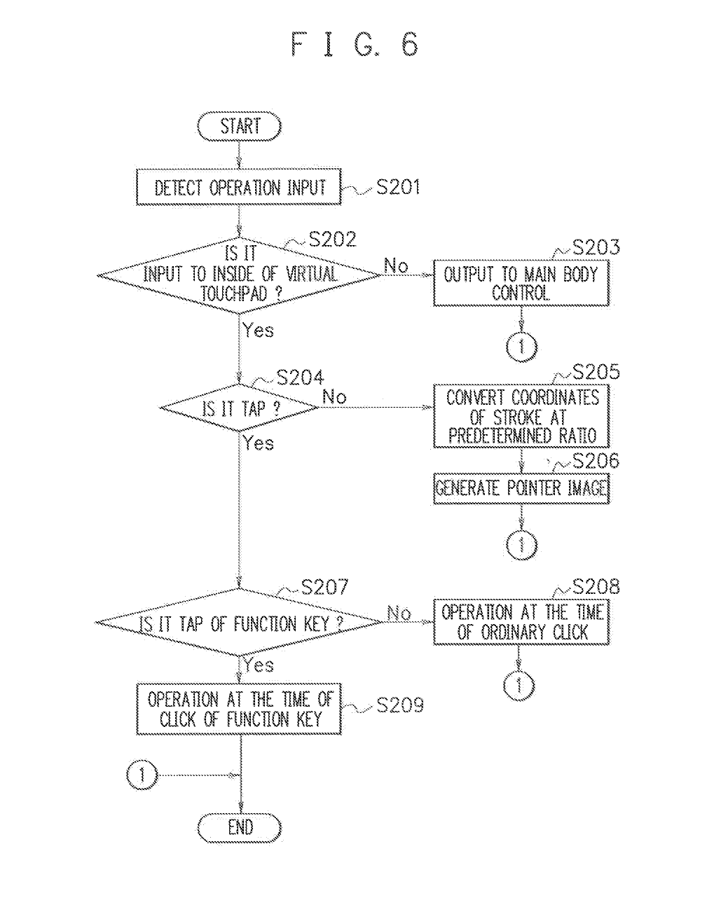

Then, operation input processing in the extended display utilization environment using the virtual touchpad 110 is described below with reference to the flow chart shown in FIG. 6. When the touch panel 101 has detected any operation input, operation input processing is started (S201). The touch panel 101 judges whether the operation input is that to the inside of the virtual touchpad 110.

Here, preferably, the judgment criterion whether the operation input is that to the inside of the virtual touchpad 110 is such that when the start point of the operation input is located inside a predetermined region occupied by the virtual touchpad 110, it is judged as input to the inside of the virtual touchpad 110.

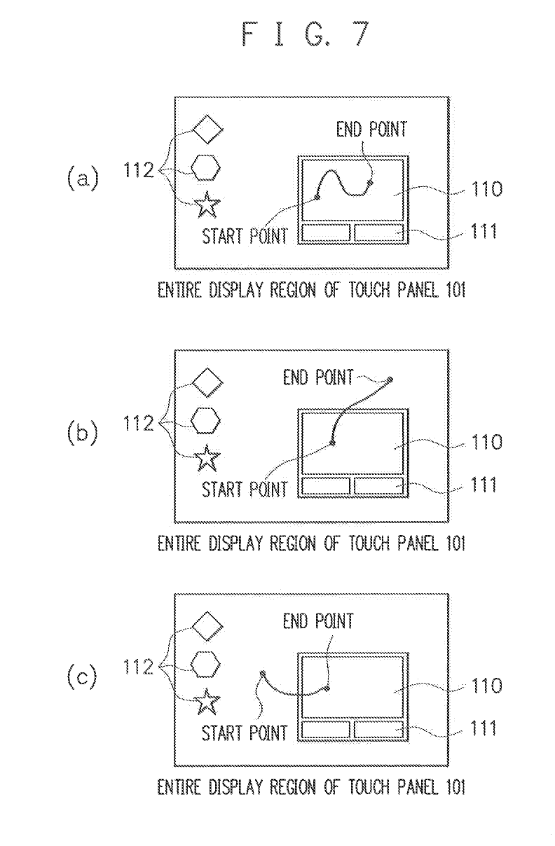

Stroke completed within the virtual touchpad 110 as shown in FIG. 7(a) is definitely input to the virtual touchpad 110. In FIG. 7(b), the start point is located inside the virtual touchpad 110. Thus, the stroke is input to the virtual touchpad 110. In FIG. 7(c), the start point is located outside the virtual touchpad 110. Thus, the stroke is not input to the virtual touchpad 110. According to this configuration, even in case of a long stroke, the operation is reflected in the input without stress to the user. At the same time, an action such as drag and drop into the virtual touchpad 110 can work appropriately.

When the operation input is not operation input to the virtual touchpad 110, input information (such as coordinate information) thereof is outputted for the purpose of control in the information processing device 100 main body (S203). When the operation input is operation input to the virtual touchpad 110, input information (such as coordinate information) thereof is outputted to the pointer operation input receiving means 105 for the purpose of control of the extended display utilization environment displayed on the external display 102. The pointer operation input receiving means 105 receives the input of user operation as input of operation of the pointer.

The pointer operation input receiving means 105 judges whether the operation input is tap (S204). In case of not being tap, coordinate conversion is performed on the input coordinates such that the stroke may be reflected in the external display 102 at a predetermined magnification (S205). The pointer display control means 106 generates a pointer image of the locus based on the converted coordinates and thereby performs display control (S206).

On the other hand, in case of tap, the pointer operation input receiving means 105 judges the tap is tap of the function key 111 (S207). In case of not being tap of the function key 111, operation corresponding to ordinary click is performed (S208). In contrast, in case of tap of the function key 111, operation to be performed when the function key 111 is clicked is performed (S209). Preferably, this operation is to display a context menu located at a position presently indicated by the pointer 113.

As described above, when the pointer display control means 106 controls display of the pointer 113 on the basis of the input of operation of the pointer 113, the user is allowed to perform comfortable operation of the extended display utilization environment.

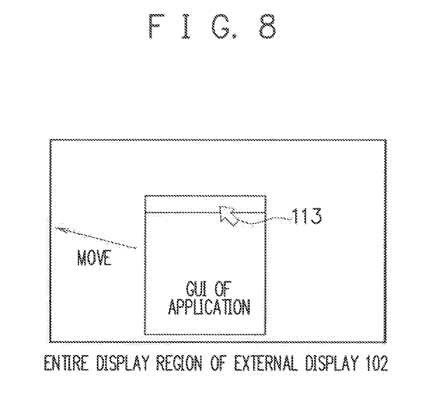

Further, it is preferable that pointer cursors (including the pointer 113) provided by the OS 21 are not displayed on the touch panel 101. An exception to this, that is, a situation that the pointer cursor is to be displayed, is that as shown in FIG. 8, a window on the extended display utilization environment side is dragged and moved with the pointer 113. In this case alone, the pointer 113 is displayed on the touch panel 101.

However, when the user's finger or the like is removed from the touch panel 101 so that the operation input to the touch panel 101 becomes no longer detected, the pointer display control means 106 stops displaying the pointer 113 on the touch panel 101 and simultaneously performs the processing of displaying the pointer 113 in the center or the like of the display region of the external display. Such a configuration of the present embodiment provides a more comfortable extended display utilization environment.

This application is based upon and claims the benefit of priority from Japanese patent application No. 2013-210926, filed on Oct. 8, 2013, the disclosure of which is incorporated herein its entirety by reference.

### DESCRIPTION OF REFERENCE NUMERALS

1 Information processing system

100 Information processing device (tablet PC)

101 Touch panel

102 External display

103 Display cable

104 Startup judging means

105 Pointer operation input receiving means

106 Pointer display control means

110 Virtual touch pad

111 Function key

112 Icon(s)

113 Pointer

What is claimed is:

1. An information processing device comprising:
a touch panel for displaying a virtual touchpad in a first region serving as a part of an entire display region;
startup judging means of, when an icon displayed in the display region of the touch panel and causing execution of predetermined processing of an application related in advance by predetermined operation is dragged and dropped into the first region, performing control of starting an application concerning the icon and then displaying a display screen of the application on an external display;
pointer display control means of performing control of displaying a pointer on the display screen of the external display; and
pointer operation input receiving means of receiving input of user operation to the first region, as input of operation of the pointer, wherein
the pointer display control means controls display of the pointer on the basis of the input of operation of the pointer.

2. The information processing device according to claim 1, wherein in a case that operation input by a user has been detected, when the start point of the operation input is located inside the first region, the touch panel transfers the operation input to the pointer operation input receiving means.

3. The information processing device according to claim 1, wherein as a result of the input of operation of the pointer, except for a case that the pointer has moved from the display region of the external display to the display region of the touch panel, the touch panel does not display a pointer cursor in the display region.

4. The information processing device according to claim 3, wherein when operation input received by the pointer operation input receiving means has become absent, the pointer display control means performs control of displaying the pointer having been moved from the display region of the external display to the display region of the touch panel, in the display region of the external display.

5. The information processing device according to claim I, wherein the virtual touchpad includes a function key used for displaying a context menu concerning a part indicated by the pointer.

6. An information processing method employed in an information processing device provided with a touch panel and connected to an external display, comprising:
a touch panel control step of displaying a virtual touchpad in a first region serving as a part of an entire display region of the touch panel;
a startup judgment step of when an icon displayed in the display region of the touch panel and causing execution of predetermined processing of an application related in advance by predetermined operation is dragged and dropped into the first region, starting an application concerning the icon;
an application screen display step of performing control of displaying a display screen of the application onto the external display;
a pointer display control step of performing control of displaying a pointer on the display screen of the external display; and
a pointer operation input receiving step of receiving input of user operation to the first region, as input of operation of the pointer, wherein
in the pointer display control step, display of the pointer is controlled on h basis of the input of operation of the pointer.

7. A program for causing an information processing device provided with a touch panel and connected to an external display to execute:
touch panel control processing of displaying a virtual touchpad in a first region serving as a part of an entire display region of the touch panel;
startup judgment processing of, when an icon displayed in the display region of the touch panel and causing execution of predetermined processing of an application related in advance by predetermined operation is dragged and dropped into the first region, starting an application concerning the icon;
application screen display processing of performing control of displaying a display screen of the application onto the external display;
pointer display control processing of performing control of displaying a pointer on the display screen of the external display; and
pointer operation input receiving processing of receiving input of user operation to the first region, as input of operation of the pointer, wherein
in the pointer display control processing, display of the pointer is controlled on the basis of the input of operation of the pointer.
